(19) United States
(12) Patent Application Publication
(10) Pub. No.: US 2003/0084211 A1
(43) Pub. Date: May 1, 2003

(54) Monitoring method and system for remote input/output blocks

(76) Inventor: Derald J. Herinckx, Charlottesville, VA (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/021,004

(22) Filed: Oct. 29, 2001

(51) Int. Cl. G06F 3/00

(52) U.S. Cl. 710/19

(57) ABSTRACT

A user interface is incorporated into an I/O Block. The user interface preferably includes a small screen on which, for example, the description or identification of the module, communication settings, I/O addresses, tagnames, current values, I/O reference descriptions, analog value trends and force and fault status for the I/O Block can be displayed. The user interface also preferably includes a user input device, for example, a small keypad, that allows the user to input commands or solicit data from the I/O Block. With the user interface incorporated in the I/O Block, a technician servicing the Block need not carry any equipment and can work with several I/O Blocks at once.

### FIELD OF THE INVENTION

The present invention relates to the field of Input/Output blocks that are located remotely from a master controller. More specifically, the present invention relates to the field of monitoring and maintenance for remote Input/Output blocks. The present invention provides a user interface that is incorporated into each Input/Output block so that a technician can monitor or control the Input/Output block at the location of the block without requiring any additional electronic device.

### BACKGROUND OF THE INVENTION

Industrial processes frequently have parameters such as flow, temperature and pressure that must be monitored and controlled. Consequently, electronic circuits and systems are developed to automatically provide the necessary oversight of these industrial and other processes.

The electronic equipment for many industrial and other processes includes a dedicated computer, controller, processor or logic circuit. A microprocessor or logic circuit may be embodied in, or include, an integrated circuit (IC) or computer chip into which a specific circuit and functionality have been built. One alternative to a specific prefabricated chip is a field programmable gate array (FPGA) that can be programmed to provide a particular desired functionality.

Such electronic logic devices may monitor sensors, control automated equipment or simply process or relay data. In may applications, information or parameters from one system will impact how other system are operated. Consequently, in most applications it is necessary or advantageous to tie these various electronic systems together so that, for example, the electronic equipment in a production plant or factory or for a particular industrial process can be monitored and controlled from a central location or by a master controller.

However, depending on the application, i.e., the process monitored or controlled, or the functionality performed, an electronic circuit may be an analog circuit or a digital circuit, may have specific operating parameters (e.g., voltage ranges, current capacity, isolation times, etc.) and may have specific communication protocols, etc. Consequently, there are difficulties interfacing such a wide variety of disparate systems. In response, configurable devices known as Input/Output Blocks (“I/O Blocks”) have been developed to serve as interfaces between electronic systems and centralized monitoring equipment. The I/O configuration for I/O blocks can generally be customized to provide the most efficient I/O configuration for a given application.

I/O Blocks are self-contained. I/O Blocks may be located remote from a master controller and near the electronic systems that they interface. For example, Blocks can be installed virtually anywhere, up to thousands of feet from the master controller, i.e., a programmable logic controller (PLC), data collection or control system (DCS) or computer (PC). Frequently, a number of I/O Blocks are housed together in a cabinet. FIG. 1 illustrates a conventional cabinet (100) housing a number of I/O Blocks (101).

One problem with I/O Blocks (101) is servicing and maintaining them, particularly when they are located remote from the master controller or computer at locations closer to the equipment they service. In order to provide troubleshooting and maintenance for I/O Blocks, technicians require the ability to view the I/O Block's configuration and status, force input/output and manage faults. These functions are typically provided through software running on a computer that is connected to the master controller for the I/O Blocks. However, because the master controller and associated computer are typically remote from the I/O Block cabinet (100), a technician cannot get the information about an I/O Block required while at the cabinet (100) where the I/O Block (101) is actually located.

One attempt to facilitate servicing and maintenance of I/O Blocks has included providing a hand-held device (103). The hand-held unit (103) can be taken with a technician to the location of the I/O Blocks (101). The unit (103) is then connected (105) to a particular I/O Block (101). The hand-held unit (103) provides a small screen (104) and a keypad (102). Consequently, the technician can communicate with the I/O Block (101) through the hand-held unit (103) to view the I/O Block's configuration and status, force input/output and manage faults for trouble-shouting and maintenance purposes.

There are several problems with using such a hand-held unit. First, the unit must be taken with a technician when servicing I/O Blocks. Second, only one I/O Block can be connected and worked with at a time. The technician will not have the ability to view data for several Blocks simultaneously, display trends for analog input/output and display tagnames assigned at the controller level.

A second similar approach to the problem is illustrated in FIG. 2. In FIG. 2, instead of a hand-held unit, a laptop computer (120) with a screen (122) and keyboard (121) is taken to the location of the I/O Blocks (101). Again, the laptop (120) can be connected (125) to a particular I/O Block (101).

While the laptop (120) and associated software provide more troubleshooting and maintenance functionality than the hand-held unit (103; FIG. 1), there are still problems. Again, the laptop (120) must be carried with the technician and connected to the I/O Block being serviced. I/O Blocks (101) and cabinets (100) are typically located in industrial environments where there may be a lot of dirt, dust, moisture, etc. This environment is very hard on a laptop computer (120) and may dramatically shorten the useful life of an expensive piece of equipment.

Consequently, there remains a need for an improved method and system of servicing I/O Blocks at the actual location of the Blocks.

SUMMARY OF THE INVENTION

The present invention meets the above-described needs and others. Specifically, the present invention provides an improved method and system of servicing I/O Blocks at the actual location of the Blocks.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as an Input/Output Block with a user interface integrated with the Input/Output Block for providing data about the Input/Output Block. Preferably, the user interface includes a screen; and a user input device. In one preferred embodiment, the user input device may be a keypad, i.e., a collection of keys or buttons. In another embodiment, the user interface may include a touch-screen.

Preferably, the user interface displays a description of the I/O Block; I/O addresses and I/O tagnames of the I/O Block; analog trends for points of the I/O Block; Fault Status of the I/O Block; Force Status of the I/O Block; and/or communication settings of the I/O Block.

The present invention also encompasses the methods of making and operating an Input/Output Block with an integral user interface. For example, the present invention encompasses a method of making an Input/Output Block by forming an Input/Output Block; and providing a user interface integrated with the Input/Output Block.

The present invention also encompasses a method of operating an Input/Output Block by retrieving data from the Input/Output Block and entering data to the Input/Output Block through a user interface integrated with the Input/Output Block. This may include configuring the Input/Output Block with the integrated user interface.

The method may also include displaying a description, identification or tagname of the I/O Block with the user interface; displaying an I/O address of the I/O Block with the user interface; displaying an analog value trend of the I/O Block with the user interface; displaying a fault status of the I/O Block with the user interface; displaying a force status of the I/O Block with the user interface; and/or displaying communication settings of the I/O Block with the user interface.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 illustrates a prior art method of using a hand-held unit to service remote I/O Blocks.

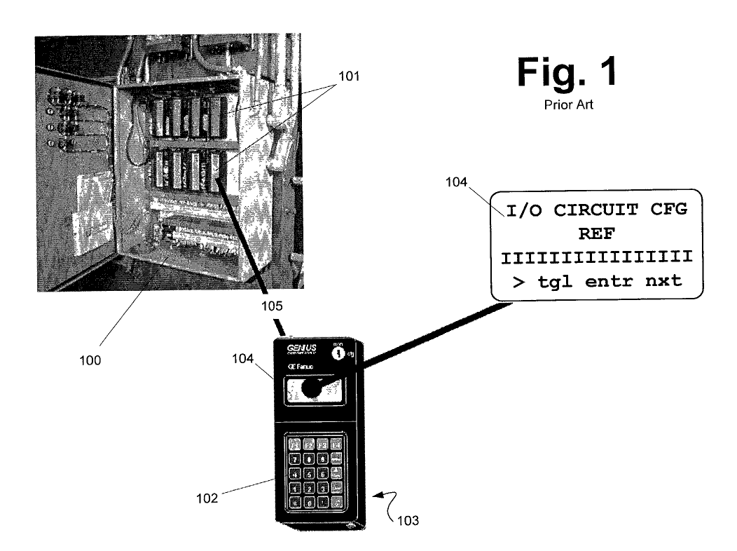

FIG. 2 illustrates a prior art method of using a laptop computer to service remote I/O Blocks.

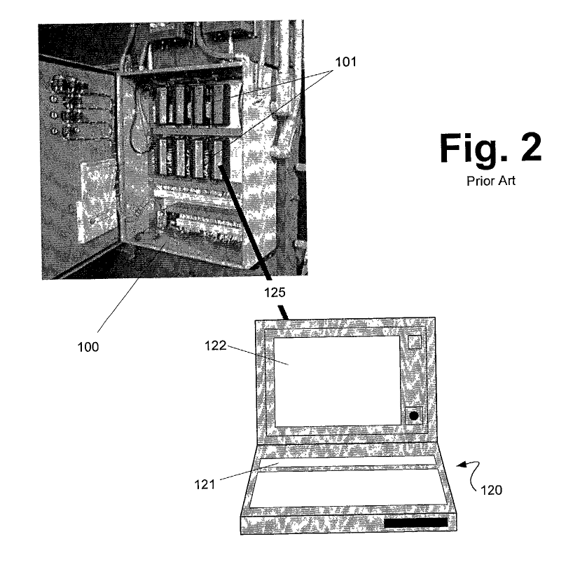

FIG. 3 illustrates an improved I/O Block with an on-board user interface according to the principles of the present invention.

FIG. 4 illustrates an alternative embodiment of an improved I/O Block with an on-board user interface according to the principles of present invention.

FIG. 5 illustrates exemplary output screens from the on-board user interface of an I/O Block according to the present invention.

Throughout the drawings, identical elements are designated by identical reference numbers.

### DETAILED DESCRIPTION OF THE PREFERRED EMBODIMENTS

According to the principles of the present invention, a user interface is incorporated into an I/O Block. The user interface preferably includes a small screen on which, for example, the description or identification of the module, communication settings, addresses, tagnames, current values, I/O reference descriptions, analog value trends and force and fault status for the I/O Block can be displayed. The user interface also preferably includes a user input device, for example, a small keypad that allows the user to input commands or solicit data from the I/O Block. With the user interface incorporated in the I/O Block, a technician servicing the Block need not carry any equipment and can work with several I/O Blocks at once.

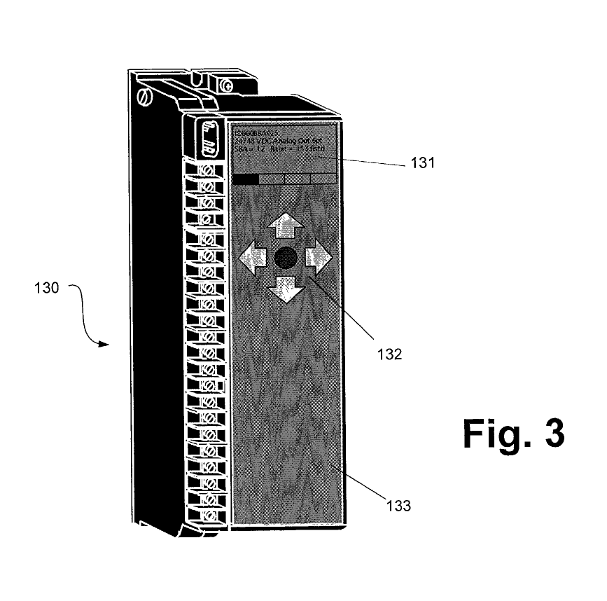

FIG. 3 illustrates an improved I/O Block (130) according to the present invention. The I/O Block (130) of the present invention can be any type of I/O Block, e.g., analog input, analog output, digital input, digital output, etc. The I/O Block of the present invention can be put to any purpose for which a conventional I/O Block would be used.

However, the I/O Block (130) of the present invention incorporates a user interface that allows the Block to be serviced for maintenance or troubleshooting. With the integrated user interface, the Block (130) can be serviced wherever it is located and without the need for any additional electronic equipment. The user interface can be driven by the firmware already present in the I/O Block. Enhancement of the firmware to support the user interface described herein will be within the ability of one skilled in the art who is provided with this disclosure of the present invention.

As shown in FIG. 3, the user interface of the present invention preferably includes a small screen (131) on which information about the I/O Block (130) can be displayed. The display on the screen (131) can be controlled by the user to provide the user with whatever data is necessary to service the Block (130). For example, the screen (131) may display the description or identification of the module, communication settings, I/O addresses, tagnames, current values, I/O reference descriptions, analog value trends and force and fault status.

The user interface of the present invention also includes a user input device with which the user can input commands or request information from the Block (130). The user input device can be, for example, a small keypad (132) such as that pictured in FIG. 3. The keypad (132) can be used as follows. The four arrow keys are used to move through menus displayed on the screen (131). The center key is pressed to select an option currently highlighted or selected on the screen (131). In this way, the user can move through the menus of the interface to input commands or retrieve the data required to service the Block (130).

Preferably, the screen (131) and user input device (132) are integrated into a casing or housing (133) of the I/O Block. On the exterior of the Block (130), the user interface is readily accessible to the operator.

Additionally, the user input device of the present invention can be any user input device that allows a user to interface with the Block (130). While the keypad (132) pictured in FIG. 3 is a simple and preferred user input device, other devices may be used, including, for example, a trackball or touch-pad.

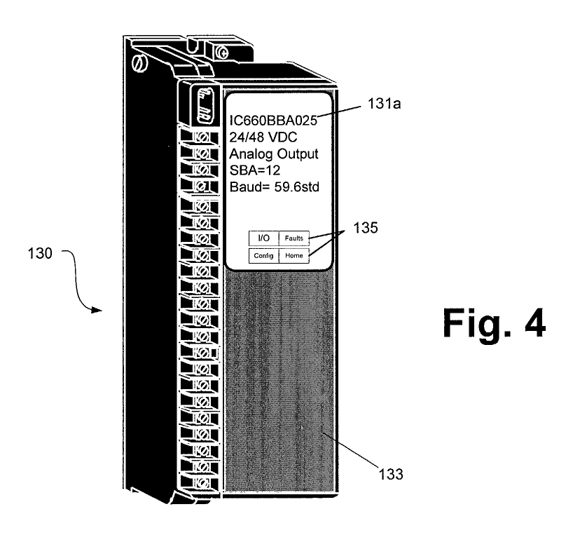

FIG. 4 illustrates another preferred embodiment of the present invention. As shown in FIG. 4, the screen (131) and keypad (132) shown in FIG. 3 can be replaced with, for example, a touch-sensitive screen (131a). The touch screen (131a) can provide the same display as the screen (131) described above.

Additionally, the user can input commands or request data by touching portions of the screen (131a). For example, the display may include illustrated function keys (135) that can be touched by the user to activate that function or navigate through the menus of the system.

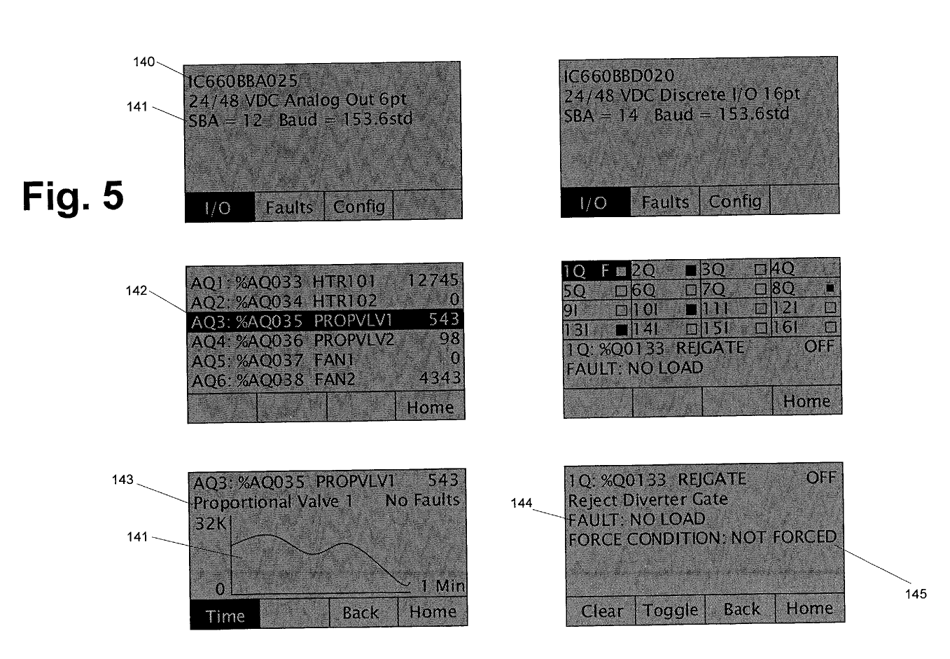

FIG. 5 illustrates a number of exemplary screens that might be displayed by the user interface of the present invention. These screens will provide an appreciation of how the user interface of the present invention operates and can be operated.

As shown in FIG. 5, the display of the user interface of the present invention may include a description or identification of the I/O Block (140) and communication settings (141). The display may also indicate the I/O address, tagname and current value data (142) for the I/O Block. The I/O reference description (143) and an analog value trend (141) may also be displayed. The analog value trend (141) is preferably a graphic illustration of the underlying data and represents a functionality not previously available with hand-held units. Finally, the display may include the fault status (144) and the force status (145) of the I/O Block.

In addition, the user interface of the present invention can provide the ability to configure the I/O Blocks, i.e., I/O sense, fault response, filter times, redundancy, etc. The user interface also preferably provides the ability to display this same configuration data, as well as the data indicated above, downloaded from a centralized configuration utility. The user input device, e.g., operator function keys, can be used to select and zoom in on items on the screen and display data in progressive levels of detail.

An additional benefit of the integration of the user interface into the I/O Block is a potential for cost/size savings. Traditional I/O modules communicate I/O and module status through light emitting diodes (LED's). These LED's consume space and power. It is conceivable that the cost of the integrated user interface will be offset, and perhaps completely covered, by the savings from components that are no longer required, e.g., LED's, lightpipes, larger power supply, etc.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. An Input/Output Block comprising:
an Input/Output Block; and
a user interface integrated with said Input/Output Block for providing data about said Input/Output Block.

2. The Block of claim 1, wherein said user interface further comprises:
a screen; and
a user input device.

3. The Block of claim 2, wherein said user input device comprises a keypad.

4. The Block of claim 1, wherein said user interface comprises a touch-screen.

5. The Block of claim 1, wherein said user interface displays a description, identification or tagname of the I/O Block.

6. The Block of claim 1, wherein said user interface displays an I/O address of the I/O Block.

7. The Block of claim 1, wherein said user interface displays an analog value trend of the I/O Block.

8. The Block of claim 1, wherein said user interface displays a fault status of the I/O Block.

9. The Block of claim 1, wherein said user interface displays a force status of the I/O Block.

10. The Block of claim 1, wherein said user interface displays communication settings of the I/O Block.

11. A method of making an Input/Output Block comprising:
forming an Input/Output Block; and
providing a user interface integrated with said Input/Output Block.

12. The method of claim 11, wherein said providing a user interface further comprises:
providing a screen; and
providing a user input device.

13. The method of claim 12, wherein said providing a user input device comprises providing a keypad.

14. The method of claim 11, wherein said providing a user interface further comprises providing a touch-screen.

15. A method of operating an Input/Output Block comprising retrieving data from said Input/Output Block and entering data to said Input/Output Block through a user interface integrated with said Input/Output Block.

16. The method of claim 15, further comprising configuring said Input/Output Block with said integrated user interface.

17. The method of claim 15, further comprising displaying a description, identification or tagname of the I/O Block with said user interface.

18. The method of claim 15, further comprising displaying an I/O address of the I/O Block with said user interface.

19. The method of claim 15, further comprising displaying an analog value trend of the I/O Block with said user interface.

20. The method of claim 15, further comprising displaying a fault status of the I/O Block with said user interface.

21. The method of claim 15, further comprising displaying a force status of the I/O Block with said user interface.

22. The method of claim 15, further comprising displaying communication settings of the I/O Block with said user interface.

23. An Input/Output Block comprising:
a casing of said Input/Output Block; and
user interface means integrated with said casing of said Input/Output Block for providing data about said Input/Output Block.

24. The Block of claim 23, wherein said user interface means comprise:
a screen; and
a user input device.

25. The Block of claim 23, wherein said user interface means comprise a touch-screen.
